(19) United States
(12) Patent Application Publication
(10) Pub. No.: US 2010/0110412 A1
(43) Pub. Date: May 6, 2010

(54) SYSTEMS AND METHODS FOR LOCALIZATION AND MAPPING USING LANDMARKS DETECTED BY A MEASUREMENT DEVICE

(75) Inventors: Sumit Basu, Bangalore (IN); Bob Touchton, Phoenix, AZ (US); Dave Galbraith, Phoenix, AZ (US); Kaniyanoor Srinivasan Srikanth, Bangalore (IN); Vijayendra Setty, Bangalore (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/262,552

(22) Filed: Oct. 31, 2008

(51) Int. Cl. G01C 3/00; G01C 21/00

(52) U.S. Cl. 356/3; 701/208

(57) ABSTRACT

Systems and methods for localization and mapping an environment using a measurement device are provided. One system includes a vehicle, first and second measurement devices configured to generate range/azimuth data for reference landmarks in the environment, a processor, and memory. The memory includes a map module storing data representing a map of the environment including known coordinates for the plurality of reference landmarks. One method includes generating a map of the environment based on known coordinates for each of the plurality of reference landmarks, receiving range and azimuth data for each of a plurality of candidate reference landmarks from a measurement device, and identifying each of the plurality of reference landmarks in the plurality of candidate reference landmark. The method further includes associating the plurality of candidate reference landmarks with the plurality of reference landmarks in the map and localizing a mobile platform based on the associating step.

### FIELD OF THE INVENTION

The present invention generally relates to navigation systems, and more particularly relates to systems and methods for determining the position and heading/orientation of a mobile platform in an environment (“localization”) using a measurement device (e.g., a light detection and ranging (LIDAR) device) that is capable of detecting the range, azimuth, and elevation of landmarks and a digital map that contains the location of previously surveyed landmarks (“reference landmarks”), and further, autonomously updating the map to include the presence and position of additional landmarks (“derived landmarks”) that can be used in subsequent mobile platform operations.

### BACKGROUND OF THE INVENTION

Contemporary reference navigation systems that use object detection devices (e.g., a light detection and ranging (LIDAR) devices and stereo-camera-based devices) have a large dependence on additional instruments and/or motion sensors. For example, these navigation systems may include a global positioning system (GPS), a differential global positioning system (DGPS), a real-time kinematic global positioning system (RTK-GPS), an odometer, an inertial measurement unit (IMU), and/or other similar instrument(s) and/or sensor(s) for achieving an accuracy to the degree that the contribution from the object detection device is characterized as an aiding source to the GPS/DGPS/RTK-GPS/odometer/IMU and any associated motion sensors. Dependency on such additional technologies and/or sensors not only increases the overall cost of a navigation system, but also reduces the reliability of the system due to the fact that failure of any of the additional instruments and/or sensors may lead to total system failure or performance and accuracy degradation.

Another known class of navigation systems referred to as a SLAM (Simultaneous Localization and Mapping) system, starts in a known position in its initial environment that presumably consists of landmarks that can be detected by the system but whose locations are not known. In SLAM systems, as the system and its sensor(s) moves and perceives landmarks, the system updates a digital map with data for the newly detected landmarks consisting of its relative location with respect to the mobile system. The system simultaneously localizes itself using the continuously updated map. While this method has been shown to provide sufficient accuracy in some applications, its accuracy degrades as it moves further away from its initial position.

Accordingly, it is desirable to provide systems and methods for determining the position and orientation of a mobile platform in an environment using a measurement device configured to detect the range, azimuth, and elevation of landmarks, and that is devoid of additional instruments and/or motion sensors and without the accuracy degradation and other shortcomings associated with prior navigation systems. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Various embodiments provide apparatus for mapping an environment having a plurality of reference landmarks. One apparatus comprises a measurement device configured to generate range and azimuth data for each of the plurality of reference landmarks, a processor coupled to the measurement device, and memory coupled to the processor. The memory comprises a map module storing data representing a map of the environment including known coordinates for the plurality of reference landmarks.

Systems for mapping an environment having a plurality of reference landmarks are also provided. A system comprises a mobile platform, a first measurement device coupled to the mobile platform and configured to generate range and azimuth data for the plurality of reference landmarks, and a second measurement device coupled to the mobile platform and configured to generate range and azimuth data for the plurality of reference landmarks. The system further comprises a processor coupled to the first and second measurement devices, and memory coupled to the processor. The memory comprises a map module storing data representing a map of the environment including known coordinates for the plurality of reference landmarks.

Also provided are methods for localizing a mobile platform in an environment having a plurality of reference landmarks. One method comprises the steps of generating a map of the environment based on known coordinates for each of the plurality of reference landmarks, receiving range and azimuth data for each of a plurality of candidate reference landmarks from a measurement device, and identifying each of the plurality of reference landmarks in the plurality of candidate reference landmark. The method further comprises the steps of associating the plurality of candidate reference landmarks with the plurality of reference landmarks in the map and localizing a mobile platform based on the associating step.

### BRIEF DESCRIPTION OF THE DRAWINGS

The present invention will hereinafter be described in conjunction with the following drawing figures, wherein like numerals denote like elements, and

FIG. 1 is a block diagram of one embodiment of a system for determining the position and heading/orientation of the system by creating and using and updating a map of landmarks in an environment; and

FIG. 2 is a diagram illustrating a mobile platform comprising the system of FIG. 1 that is capable of detecting the landmarks in the environment and using a map managed by the system of FIG. 1 to determine its own position and heading/orientation.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Various embodiments of the present invention provide mobile systems and methods that use landmarks at known locations in an environment to determine the position and heading/orientation of the mobile platform in an environment and represent the position in a digital map of the environment so that the environment may be traversed by the mobile platform, such landmarks being referred to hereinafter as “reference landmarks.” Various other embodiments provide apparatus for mapping an environment having a plurality of reference landmarks, some of which already may be present in the environment, which when detected, but yet to be identified/associated as reference landmarks are referred to hereinafter as “candidate reference landmarks.” Other landmarks that are strategically added to the environment at known locations to enhance system precision and accuracy are referred to herein after as “temporary reference landmarks.” Further, the invention provides additional systems and methods that use the reference landmarks to identify and add to the digital map additional landmarks that were not included in the original version of the map given to the system, but are detected by the system during operation. Such additional landmarks are referred to hereinafter as “derived landmarks.” Additionally, systems and methods are included for using the correlation of landmarks in the digital map and landmarks detected by the system to estimate the position and orientation of the system.

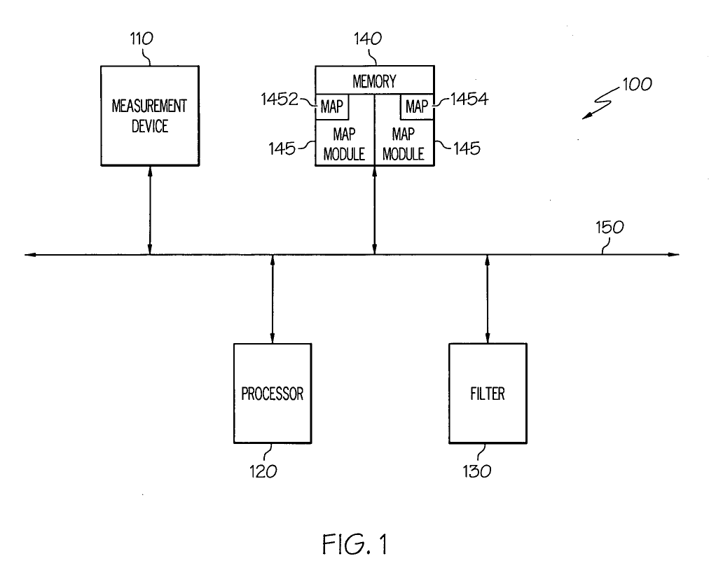

Turning now to the figures, FIG. 1 is a block diagram of one embodiment of a system 100 for determining the position and orientation of system 100 by creating and using a map of landmarks in an environment. At least in the embodiment illustrated in FIG. 1, system 100 comprises one or more measurement devices 110, a processor 120, a filter 130, and memory 140 coupled to one another via a bus 150. The following description refers to measurement device 110; however, it is noted that such reference may include one or more measurement devices 110.

Measurement device 110 may be any measurement device known in the art or developed in the future capable of detecting objects in an environment and generating range, azimuth, and/or elevation data representing the relative position of such objects. In one embodiment, measurement device 110 is a light detection and ranging (LIDAR) manufactured by SICK, Inc. of Waldkirch, Germany, which includes among other models, model number LMS221-30206. In another embodiment, measurement device 110 is a Spinning Line Laser Rangefinder (SPLINE) manufactured by RedZone Robotics, Inc. of Pittsburg, Pa. Other embodiments may use a measurement device 110 manufactured by another entity. In yet another embodiment, measurement device 110 includes a 180 degree field-of-view such that when two measurement devices 110 are used, system 100 is capable of scanning its environment a full 360 degrees. The data generated by measurement device 110 is transmitted to processor 120 for data processing of the sensed data.

Processor 120 may be any processing device known in the art or developed in the future capable of processing the data generated by a measurement device 110 and transforming the data into landmark data. Processor 120 is also configured to generate a map 1454 of the environment surrounding system 100 based on the data received from measurement device 110, which map is transmitted to filter 130 and then to memory 140 for storage.

Filter 130 may be any hardware, software, device, system, or combinations thereof capable of “smoothing” data transmitted by processor 120. In one embodiment, filter 130 is a Kalman filter with a constant acceleration model. Other embodiments of filter 130 may be a sigma-point filter, a particle filter, an extended Kalman filter (EKF), or the like filter. Filter 130, in other embodiments, may be software that is executed by processor 120 to filter the output of system 100.

Memory 140 may be any hardware, software, device, system, or combinations thereof capable of storing sensed data. In one embodiment, memory 140 includes one or more map modules 145. In one embodiment, one map module 145 is configured to store a map 1452 of an environment generated by an external device (not shown) that is based on a local or global coordinate system, such map 1452 being discussed in greater detail below. In another embodiment, one map module 145 is configured to store one or more map(s) 1454 generated by processor 120. In yet another embodiment, one map module 145 is configured to store map 1452 and map 1454. In still another embodiment, one map module 145 is configured to store map 1452 and a second map module 145 is configured to store map 1454.

Map 1452 is an a priori map of an environment containing a plurality of reference landmarks (e.g., temporary reference landmarks strategically placed in the environment and/or previously surveyed reference landmarks) and forms the basis from which processor 120 generates map 1454. Specifically, an initial version of map 1452 is generated external to system 100 and contains the location of one or more reference landmarks having positions that are referenced on a local and/or global coordinate system. Specifically, map 1452 is generated by strategically placing temporary reference landmarks in the environment and/or by surveying the environment for reference landmarks, and determining the location of each temporary reference landmark and/or reference landmark using, for example, a global positioning system (GPS), a range finder, or other positioning technology or method. The coordinates and/or position of each temporary reference landmark and/or reference landmark are then recorded to generate map 1452.

Map 1454, which may, depending on the detectable landmarks in the vicinity of system 100, include reference landmarks, temporary reference landmarks, and/or derived landmarks, is generated by processor 120 using the known coordinates and/or position of each of the reference landmarks and/or each temporary reference landmark included in map 1452. In one embodiment, system 100 is placed in the environment while the temporary reference landmarks remain in their recorded positions. Measurement device 110 then detects various characteristics (e.g., trees, rocks, building corners, lampposts, temporary reference landmarks, etc.) of the environment, transforms these characteristics into candidate landmark data, and transmits the candidate landmark data to processor 120 for processing. Processor 120 then processes the candidate landmark data and uses a feature extraction algorithm to identify and extract reference landmarks and derived landmarks from the candidate landmark data. Once the reference landmarks have been identified, processor 120 determines the spatial relationship between each derived landmark and two or more of the reference landmarks. After the various spatial relationships are determined, processor 120 uses the spatial relationships and the known coordinates and/or position of each reference landmark in the environment (as stored in map 1452) to map the position of each corresponding derived landmark, and generates map 1454 based thereon.

In another embodiment, reference landmarks (e.g., trees, rocks, building corners, lampposts, etc.) present in the environment are surveyed and recorded to generate map 1452. Measurement device 110 then detects various characteristics (e.g., trees, rocks, building corners, lampposts, temporary reference landmarks, etc.) of the environment, transforms these characteristics into candidate landmark data, and transmits the candidate landmark data to processor 120 for processing. Processor 120 then processes the candidate landmark data to extract and identify any known reference landmarks and any new landmarks (i.e., derived landmarks) located in the environment from the characteristics in the candidate landmark data. Once the various reference landmarks and derived landmarks have been identified, processor 120 determines the spatial relationship between each newly-identified derived landmark and the reference landmarks. After the various spatial relationships are determined, processor 120 uses the spatial relationships and the known coordinates and/or position of each reference landmark in the environment to map the position of each derived landmark within the environment in generating map 1454.

As discussed above, map 1454 may include previously identified derived landmarks. When system 100 is subsequently placed in the environment, the environment may have changed to include one or more characteristics that were not previously present in the environment when system 100 generated map 1454. Here, when measurement device 110 detects the new characteristic(s) (e.g., trees, rocks, building corners, lampposts, etc.) of the environment, the characteristic(s) is transformed into candidate landmark data and transmitted to processor 120 for processing. Processor 120 then processes the candidate landmark data and uses a feature extraction and association algorithm to extract and identify the derived landmark from the characteristics in the candidate landmark data. Once the one or more derived landmarks have been identified, processor 120 determines the spatial relationship between each newly-identified derived landmark and two or more of the candidate reference landmarks (which may also include previously-identified derived landmarks that are now included in map 1454). After the various spatial relationships are determined, processor 120 uses the spatial relationships and the known coordinates and/or position of each reference landmark (including previous derived landmarks) in the environment to map the position of each newly-identified derived landmark, and updates map 1454 with the newly-identified derived landmark(s).

The process of updating map 1454 may be repeated each time system 100 is subsequently placed in the environment. In doing such, previously-identified derived landmarks may be considered reference landmarks in the present placement of system 100 in the environment. Moreover, any reference landmark not detected in a subsequent placement of system 100 in the environment may be removed from map 1454.

In the situation when the environment has not changed (i.e., there are not any new landmarks from which to identify a new derived landmark), map 1454 remains unchanged (i.e., is not updated). That is, the operation of system 100 is not dependent on changes to the environment. As such, system 100 makes changes to map 1454 when changes to the environment occur, and will still function properly when changes are not detected.

In one embodiment, processor 120 derives the position of each landmark found in map 1454 by overlaying the determined spatial relationship data onto map 1452 or previous versions of map 1454, respectively, and performing a “best fit” algorithm (e.g., a least squares algorithm). In this manner, the location of each reference landmark or derived landmark may be mapped and recorded in a new map 1454 or in an updated version of map 1454, respectively. After map 1454 is generated or updated, map 1454 can be utilized to determine the position and heading/orientation of a mobile platform (e.g., a vehicle, a human, a mobile apparatus affixed to a stationary platform, etc.) as the mobile platform navigates through the environment.

Notably, maps 1452 and 1454 have been discussed above as being separate maps; however, various embodiments contemplate that maps 1452 and 1454 may be the same map. That is, map 1452 may be generated external to system 100 and updated as system 100 detects landmarks in the environment during future visits to the environment.

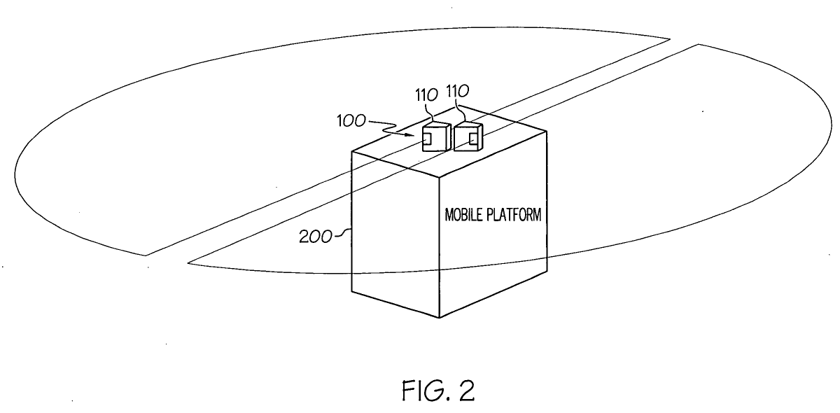

The following description may be helpful in better understanding the operation of system 100. That is, the following discussion illustrates the operation and use of one embodiment of system 100 when implemented on a mobile platform 200 (e.g., an automobile, a lawn mower, a human, a mobile apparatus affixed to a stationary platform, or other similar vehicle), as illustrated in FIG. 2. In this embodiment, measurement devices 110 are LIDAR devices.

Consider a set M of known static reference points {mᵢ}ᵢ₌^{N}^{ₘ} in a 2D coordinate system (the map frame). As mobile platform 200 moves, measurement device 110, which is mounted on mobile platform 200, moves with mobile platform 200 and generates a time varying set S(t) of image points {sᵢ}ᵢ₌₁^{N}^{ₛ}, every fixed interval of time. These image points are in the 2D coordinate frame of measurement device 110 (i.e., the LIDAR frame). If some of the reference points, belonging to a subset of M, are in the field-of-view of the measurement device 110 at the k-th time step, there will be a correspondence between this subset of M with a subset of S(tₖ). Assuming that such a correspondence has been established, let xₘ be the coordinate of a generic point in M that corresponds to a point with coordinate xₛ in S(tₖ).

The coordinates of these two points are related to each other through a time-varying transformation:

gₛₘ(t)=(Rₛₘ(t), Tₛₘ(t)),

where Rₛₘ(t) is a rotation matrix representing the orientation of the LIDAR frame with respect to the map frame, and Tₛₘ (t) is a translation between these two frames. Thus, the transformation between the two frames can be written in the following way:

xₛ(t)=gₛₘ(xₘ)=Rₛₘ(t)xₘ+Tₛₘ(t) (1)

The navigation algorithm establishes a correspondence between a subset of reference points (i.e., landmarks) in the map (map 1452 or 1454) and a subset of image points (i.e., data association) sensed in the environment, which is followed by optimally estimating the transformation gₛₘ(tₖ)=(Rₛₘ(tₖ), Tₛₘ(tₖ)) (i.e., localization) at every discrete measurement instant tₖ of measurement device 110. These estimates can be further refined using a suitable filter, such as the Kalman Filter, the Extended Kalman Filter, Sigma-Point Kalman Filter, particle filter, or the like filter.

Once the transformations Rₛₘ and Tₛₘ are estimated, an inverse transformation that maps the points in the LIDAR frame, S, to the map frame, M, may be established, as represented by the following equation:

xₘ(t)=gₘₛ(xₛ)=Rₘₛ(t)xₛ+Tₘₛ(t), (2)

where:

Rₘₛ=Rₛₘ⁻¹=Rₛₘ^{T} (3)

Tₘₛ=−Rₛₘ^{T}Tₛₘ (4)

The inverse transformation can be used to generate or update a map (i.e., map 1452 or 1454, respectively) of the environment detected by the scan of measurement device 110. As explained above, in every time step, the algorithm performs feature or point extraction, data association followed by localization and filtering. These steps are elaborated in the following discussion.

The feature extraction algorithm processes the data to differentiate landmark data from the rest of the background noise and computes the position of the landmark features in the sensor data. The feature extraction algorithm also uses distinct, point like features in the data generated by measurement device 110 for subsequent data association, reference landmark identification, and localization. Distinct, point-like features (i.e., candidate reference landmarks) are extracted from the raw data generated by measurement device 110 using any threshold-based edge detection technique known in the art.

As discussed above, data association is the process of establishing a one-to-one correspondence between some of the reference points (i.e., landmarks) in map frame M with their image points (i.e., candidate reference landmarks) in LIDAR frame S. For purpose of illustration, one embodiment is simplified to provide a three-degrees-of-freedom solution that estimates the x- and y-position and heading of mobile platform 200. A good estimate of the initial position and heading (i.e., “pose”) of mobile platform 200 is given. The probability of an image point xₛ belonging to a reference point xₘ is modeled as a Gaussian distribution given by:

p(xₛ|xₘ)=(1/(2πσₘ)⁻¹)e^{-δk(xm,xs)} (5)

where σₘ captures the uncertainty in the map coordinates of the reference point xₘ and δₖ is the Mahalanobis distance. The image point xₛ is associated with the map reference point for landmark xₘ if the Mahalanobis distance δₖ (xm, xs) satisfies the equation:

δₖ(xₘ, xₛ)≦λ (6)

where λ is a data association threshold that captures the uncertainty in the transformation gₘₛ(xₛ).

After data association, a subset of the image points in LIDAR frame S are associated with a subset of the reference points in map frame M for localization. For example, let the number of such points be denoted by Nₐ, the set of these points in LIDAR frame S can be denoted by {Xₛⁱ}, and the corresponding set in map frame M can be denoted by {Xₘⁱ}, where i ranges from 1 to Nₐ. Given these two corresponding data sets, the localization algorithm computes the rotation matrix Rₘₛ and the translation vector Tₘₛ that transforms a point {Xₘⁱ} to {Xₛⁱ} (see equation (1)).

The localization algorithm minimizes the objective function:

$${min}_{R m s , Tms} e ( {R}_{m s} , {T}_{m s} ) = {min}_{Rms , Tms} {\sum }_{i = 1}^{Ni} {‖ {x}_{m}^{i} - {g}_{m s} ( {x}_{s}^{i} ) ‖}^{2} , \qquad ( 7 )$$

wherein the minimization is performed in closed form using a Singular Value Decomposition technique. Once Rₘₛ(tₖ) and Tₘₛ(tₖ) are estimated at time step tₖ, the position x(tₖ) and heading θ(tₖ) of mobile platform 200 with respect to the map frame M, are given by:

x(tₖ)=Tₘₛ(tₖ)θ(tₖ)=tan⁻(R₂₁(tₖ)/R₁₁(tₖ)) (8)

This computation is carried out at every time step tₖ corresponding to scan data generated by measurement device 110.

The pose estimate, computed in the localization step described above, is further processed using filter 130. The position and heading estimates, computed using equation (8), are used as measurements in filter 130. Specifically, the pose estimations generated by measurement device 110 are decoupled from the estimations produced by filter 130, and are treated as raw and noisy measurements. In this manner, a linear constant acceleration state space model can be used for slow turning vehicles moving with constant acceleration.

For this embodiment, the state vector of filter 130 is given by X=(x, y, θ, \dot{x}, \dot{y}, \dot{θ}, \ddot{x}, ÿ, \ddot{θ})^{T}, where x and y are the 2D planar coordinates of mobile platform 200 in map frame M and θ denotes the heading of mobile platform 200. The variables with single and double dots on top are the corresponding rates and accelerations, respectively. The x and y coordinates may be expressed either in the local geodetic frame (i.e., x=East and y=North) or they can be in any arbitrary mapping frame of reference. The kinematic model of mobile platform 200 can be expressed in the matrix form:

Xₖ₊₁=ΦₖXₖ+wₖ, (9)

where the state transition matrix Φₖ is given by:

| | | | | | | | | |
|---|---|---|---|---|---|---|---|---|
| 1 | 0 | 0 | dt | 0 | 0 | .5dt² | 0 | 0 |
| 0 | 1 | 0 | 0 | dt | 0 | 0 | .5dt² | 0 |
| 0 | 0 | 1 | 0 | 0 | dt | 0 | 0 | .5dt² |
| 0 | 0 | 0 | 1 | 0 | 0 | dt | 0 | 0 |
| 0 | 0 | 0 | 0 | 1 | 0 | 0 | dt | 0 |
| 0 | 0 | 0 | 0 | 0 | 1 | 0 | 0 | dt |
| 0 | 0 | 0 | 0 | 0 | 0 | 1 | 0 | 0 |
| 0 | 0 | 0 | 0 | 0 | 0 | 0 | 1 | 0 |
| 0 | 0 | 0 | 0 | 0 | 0 | 0 | 0 | 1 |

and the mobile platform pose Zₖ, estimated from measurement device 110 data (equation (8)) at time tₖ, is related to the state vector by a linear measurement model:

Zₖ=HₖXₖ+vₖ (10)

In equations (9) and (10), wₖ and vₖ represent the process and measurement noise vectors, respectively, with covariance matrices E[w_{^{k}}_{w}_{ₖ}^{T}]=Qₖ and E[v_{^{k}}ᵥ_{ₖ}^{T}]=Rₖ, respectively.

Filter 130, in one embodiment, works in two distinct phases: Predict and Update. The predict phase uses the state estimate from the previous time step to produce an estimate of the state at the current time step. In the update phase, the vehicle pose, estimated from measurement device 110 data at the current time step is used to refine this prediction to arrive at a new, more accurate state estimate. In the recursive equations given below, the notation \hat{X}ᵢⱼ represents the estimate of the state at time i given observations up to, and including time j. The state of filter 130 at a given instant of time may be represented by two variables: \hat{X}ᵢⱼ which is the estimate of the state at time k, and \hat{P}_{k|k} the error covariance matrix, which is a measure of the estimated accuracy of the state estimate. The predict and update functions of filter 130 can be represented by the following equations:

### Predict:

\hat{X}_{k|k-1}=Φₖ\hat{X}_{k-1|k-1} (11)

\hat{P}ₖₖ₋₁=Φₖ\hat{P}_{k-1|k-1}Φₖ^{T}+Qₖ₋₁ (12)

### Update:

\tilde{y}ₖ=Zₖ−Hₖ\hat{X}_{k|k-1} (13)

Sₖ=HₖP_{k|k-1}Hₖ^{T}+Rₖ (14)

Kₖ=P_{k|k-1}Hₖ^{T}Sₖ⁻¹ (15)

\hat{X}_{k|k}=\hat{X}_{k|k-1}+Kₖŷₖ (16)

The first three components of the estimated state vector \hat{X}ₖₖ computed in equation (16) constitute the final estimate of the position and heading of mobile platform 200 in the algorithm.

Once the position and heading of mobile platform 200 are estimated with sufficient accuracy, map 1454 of the environment as seen by the measurement device 110 at any instant of time can be generated. The vehicle translation vector \hat{T}ₛₘ(tₖ) is the same as the estimated position vector of the vehicle and the rotation matrix \hat{R}ₛₘ(tₖ) is given by:

\hat{R}ₛₘ(tₖ)=cos(\hat{θ}ₖ) sin(\hat{θ}ₖ) −sin(\hat{θ}ₖ) cos(θₖ) (17)

where \hat{θ}ₖ is the vehicle heading at time tₖ (i.e the third component of the system state \hat{X}_{k|k} estimated in equation (16)).

From ĝₛₘ(tₖ)=(\hat{T}ₛₘ(tₖ), \hat{R}ₛₘ (tₖ)), the inverse transformation ĝₘₛ(tₖ)=(\hat{T}ₘₛ(tₖ), \hat{R}(tₖ)) can be estimated using equations (2) and (3). Using this inverse transformation, the map location vector xₘ of any newly identified landmark xₛ in the field-of-view of measurement device 110 is estimated using the transformation equation:

xₘ=ĝₘₛ(xₛ(tₖ))=(\hat{R}ₘₛ(tₖ)xₛ(tₖ)+\hat{T}ₛₘ(tₖ)) (18)

The existing map (i.e., map 1452) of reference landmarks can then be updated with the new map (i.e., map 1454) of candidate reference landmarks generated by this method or map 1454 may be updated with derived landmarks to create an updated version of map 1454. Such reference landmarks may come from any object “seen” by measurement device 110 during its journey through the environment. Furthermore, map 1454 may be updated during future travels through the environment so that map 1454 remains up-to-date.

After map 1454 is created, map 1454 can be used by mobile platform 200 while traveling through the environment. Specifically, processor 120 can identify landmarks in the data generated by measurement device 110 and associate the landmarks in the generated data with the corresponding reference landmarks in map 1454 such that the current position and heading/orientation of mobile platform 200 can be estimated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. An apparatus for mapping an environment having a plurality of reference landmarks, comprising:
a first measurement device configured to generate range and azimuth data for each of the plurality of reference landmarks;
a processor coupled to the measurement device; and
memory coupled to the processor, the memory comprising a map module storing data representing a map of the environment including known coordinates for the plurality of reference landmarks.

2. The apparatus of claim 1, wherein the processor is configured to:
receive landmark data from the measurement device;
extract a plurality of candidate reference landmarks from the landmark data;
associate the plurality of candidate reference landmarks with the plurality of reference landmarks in the map; and
estimate a two-dimensional position and heading of the apparatus based on the association.

3. The apparatus of claim 2, wherein the processor is further configured to update the map during one or more subsequent measurements of the environment if the first measurement device detects a derived landmark.

4. The apparatus of claim 1, wherein the first measurement device is further configured to generate elevation data for each of the plurality of reference landmarks, and wherein the map module further comprises elevation data for the plurality of reference landmarks.

5. The apparatus of claim 4, wherein the processor is configured to:
receive landmark data from the measurement device;
extract a plurality of candidate reference landmarks from the landmark data;
associate the plurality of candidate reference landmarks with the plurality of reference landmarks in the map; and
estimate a three-dimensional position and orientation of the apparatus based on the association.

6. The apparatus of claim 5, wherein the processor is further configured to update the map during one or more subsequent visits to the environment if the first measurement device detects a derived landmark.

7. The apparatus of claim 1, wherein the first measurement device is a light detection and ranging (LIDAR) device.

8. The apparatus of claim 1, wherein the processor is further configured to:
receive range and azimuth data for each of the plurality of reference landmarks from the first measurement device;
determine a position for each of the plurality of reference landmarks based on a coordinate system; and
generate a candidate map of the reference landmarks within the environment based on the determination.

9. A system for mapping an environment having a plurality of reference landmarks, comprising:
a mobile platform;
a first measurement device coupled to the mobile platform and configured to generate range and azimuth data for the plurality of reference landmarks;
a second measurement device coupled to the mobile platform and configured to generate range and azimuth data for the plurality of reference landmarks;
a processor coupled to the first and second measurement devices; and
memory coupled to the processor, the memory comprising a map module storing data representing a map of the environment including known coordinates for the plurality of reference landmarks.

10. The system of claim 9, wherein the processor is configured to:
receive landmark data from the first and second measurement devices;
extract a plurality of candidate reference landmarks from the landmark data;
associate the plurality of candidate reference landmarks with the plurality of reference landmarks in the map; and
estimate a two-dimensional position and heading of the system based on the association.

11. The system of claim 10, wherein the processor is further configured to update the map during one or more subsequent visits to the environment if the first measurement device, second measurement device, or both detects a derived landmark.

12. The system of claim 9, wherein the first and second measurement devices are further configured to generate elevation data for each of the plurality of reference landmarks, and wherein the map module further comprises elevation data for the plurality of reference landmarks.

13. The system of claim 12, wherein the processor is configured to:
receive landmark data from the first and second measurement devices;
extract a plurality of candidate reference landmarks from the landmark data;
associate the plurality of candidate reference landmarks with the plurality of reference landmarks in the map; and
estimate a three-dimensional position and orientation of the system based on the association.

14. The system of claim 13, wherein the processor is further configured to update the map during one or more subsequent visits to the environment if the first measurement device, the second measurement device, or both detects a derived landmark.

15. The system of claim 9, wherein the first measurement device and the second measurement device are light detection and ranging (LIDAR) devices.

16. A method for localizing a mobile platform in an environment having a plurality of reference landmarks, the method comprising the steps of:
generating a map of the environment based on known coordinates for each of the plurality of reference landmarks;
receiving range and azimuth data for each of a plurality of candidate reference landmarks from a measurement device;
identifying each of the plurality of reference landmarks in the plurality of candidate reference landmark;
associating the plurality of candidate reference landmarks with the plurality of reference landmarks in the map; and
localizing a mobile platform based on the associating step.

17. The method of claim 16, further comprising the steps of:
identifying one or more derived landmarks in the plurality of candidate reference landmarks; and
updating the map with each identified derived landmark.

18. The method of claim 16, wherein generating the map comprises the steps of:
placing a plurality of temporary reference landmarks within the environment; and
determining the known coordinates for each of the plurality of temporary reference landmarks.

19. The method claim 16, wherein the localizing step comprises the step of estimating a two-dimensional position and heading of the mobile platform based on the associating step.

20. The method claim 16, further comprising the step of receiving elevation data for each of the plurality of candidate reference landmarks from the measurement device, wherein the localizing step comprises the step of estimating a three-dimensional position and orientation of the mobile platform based on the associating step.
